(19) United States
(12) Patent Application Publication
(10) Pub. No.: US 2026/0034978 A1
(43) Pub. Date: Feb. 5, 2026

(54) POWERTRAIN AND AFTERTREATMENT CONTROLS BASED ON WELL TO WHEEL EMISSIONS

(71) Applicant: Cummins Inc., Columbus, IN (US)

(72) Inventors: J. Steven Kolhouse, Columbus, IN (US); Jennifer Light-Holets, Greenwood, IN (US); Aaron Beinborn, Greenwood, IN (US)

(73) Assignee: Cummins Inc., Columbus, IN (US)

(21) Appl. No.: 19/282,233

(22) Filed: Jul. 28, 2025

Related U.S. Application Data
(60) Provisional application No. 63/679,065, filed on Aug. 2, 2024.

(51) Int. Cl. B60W 20/16; B60W 10/06; B60W 10/08; B60W 20/13

(52) U.S. Cl. CPC B60W 20/16; B60W 10/06; B60W 10/08; B60W 20/13; B60W 2510/06; B60W 2510/244; B60W 2710/06; B60W 2710/1005; B60W 2710/244

(57) ABSTRACT

A system includes a controller coupled an engine. The controller is configured to receive a first well to wheel emissions value and a second well to wheel emissions value. The controller is configured to compare the first well to wheel emissions value to a first threshold and a second threshold. The controller is configured to implement one or more aftertreatment controls comprising at least one of: causing a reductant delivery system to increase an amount of reductant provided to an aftertreatment system coupled to the engine, responsive to determining that the first well to wheel emissions value is at or above the first threshold, or causing the reductant delivery system to decrease the amount of reductant provided to the aftertreatment system, responsive to determining that the first well to wheel emissions value is at or below the second threshold.

### CROSS-REFERENCE TO RELATED APPLICATION

This application claims the benefit and priority to U.S. Provisional Patent Application No. 63/679,065, filed Aug. 2, 2024, which is incorporated herein by reference in its entirety and for all purposes.

### FIELD

The present disclosure relates to powertrain and/or aftertreatment controls based on well to wheel characteristics, such as fuel consumption and/or emissions.

### BACKGROUND

A hydrogen fueled internal combustion engine consumes hydrogen fuel to produce power (e.g., for turning a crankshaft of a system embodying the engine, such as vehicle). Unlike internal combustion engines that burn carbonaceous fuel, such as diesel fuel or gasoline, the exhaust produced by a hydrogen internal combustion engine may not include hydrocarbons or carbon oxides (e.g., carbon monoxide or carbon dioxide). However, processes related to the production of hydrogen fuel may result in the release of carbon oxides. For example, an electrolyzer system used to produce hydrogen gas may consume electricity produced from fossil fuels (e.g., coal, oil, natural gas, etc.). Similarly, in hybrid powertrain systems and/or electric vehicle systems, an electric machine may consume electricity to produce power (e.g., for turning a crankshaft of a system embodying the engine, such as vehicle). In either case, the production of electricity may result in the release of carbon oxides and/or other pollutants, such as nitrogen oxides (NOx).

### SUMMARY

One embodiment relates to a system. The system includes a controller coupled an engine. The controller includes one or more processors and one or more memory devices storing instructions that, when executed by the one or more processors, cause the controller to perform operations. The operations include: receiving a first well to wheel emissions value regarding a fuel stored at a fuel system coupled to the engine; receiving a second well to wheel emissions value regarding electrical energy stored at a battery coupled to an electric machine, the electric machine and the engine cooperating to define a powertrain; comparing the first well to wheel emissions value to a first threshold and a second threshold; implementing one or more aftertreatment controls comprising at least one of: causing a reductant delivery system to increase an amount of reductant provided to an aftertreatment system coupled to the engine, responsive to determining that the first well to wheel emissions value is at or above the first threshold, or causing the reductant delivery system to decrease the amount of reductant provided to the aftertreatment system, responsive to determining that the first well to wheel emissions value is at or below the second threshold; and adjusting a power split of the powertrain includes at least one of: increasing the power split responsive to the first well to wheel emissions value being less than the second well to wheel emissions value, or decreasing the power split responsive to the first well to wheel emissions value being greater than the second well to wheel emissions value.

Another embodiment relates to a method. The method includes: receiving a first well to wheel emissions value regarding a fuel stored at a fuel system coupled to an engine; comparing the first well to wheel emissions value to at least one of a first threshold or a second threshold; and, implementing one or more controls comprising at least one of: causing a reductant delivery system to provide a first amount of reductant to an aftertreatment system coupled to the engine responsive to the first well to wheel emissions value being at or above the first threshold, or causing the reductant delivery system to provide a second amount of reductant to the aftertreatment system responsive to the first well to wheel emissions value being at or below the second threshold. The second amount of reductant is less than the first amount of reductant.

Yet another embodiment relates to a method. The method includes: receiving a characteristic regarding a fuel stored at a fuel system coupled to an engine; and implementing one or more aftertreatment controls or one or more powertrain controls based on the received characteristic.

Still another embodiment relates to a method. The method includes: receiving a characteristic regarding a fuel stored at a fuel system coupled to an engine, the characteristic comprising an indication of a blend characteristic of the fuel stored at the fuel system; and implementing one or more aftertreatment controls or one or more powertrain controls based on the received characteristic.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a system including a hydrogen fueled internal combustion engine, according to an example embodiment.

FIG. 2 is a block diagram of a controller of the system of FIG. 1, according to an example embodiment.

FIG. 3 is a flow diagram of a method of controlling the system of FIG. 1, according to an example embodiment.

FIG. 4 is a flow diagram of a method of controlling the system of FIG. 1, according to another example embodiment.

### DETAILED DESCRIPTION

Following below are more detailed descriptions of various concepts related to, and implementations of, methods, apparatuses, computer-readable media, and systems for powertrain and/or aftertreatment controls. In particular, the powertrain and aftertreatment controls may be based on one or more well to wheel operating or characteristic values, such as fueling and/or emissions values. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As utilized herein, the term “estimating” and like terms are used to refer to determining an approximate value based on data (e.g., sensor data, historical sensor data, real-time sensor data, etc.), which may be close but not necessarily exactly the actual value. In some embodiments, estimating a current or future value can be performed using one or more models (e.g., statistical models, artificial intelligence models, machine learning models, etc.). For example, estimating a temperature of exhaust gas can include using data, such as sensor data, with a model to determine the temperature value.

As utilized herein, the term “measuring” and like terms are used to refer to determining an approximate value based on detecting or receiving information regarding the measured value/parameter (e.g., using a sensor). The measured value may be closer to the actual value (e.g., compared to “estimating” the value) but not necessarily exactly the actual value of the parameter value.

As utilized herein, a “well to wheel” emissions value refers to an estimated or actual amount of emissions produced from extraction, refinement, and usage in an end source (e.g., engine) of an energy source. For example, a well to wheel emissions value for a fuel (an energy source), such as hydrogen fuel, may include a summation of an amount of emissions associated with the production of the hydrogen fuel, the amount of emissions associated with the transportation of the hydrogen fuel, and the amount of emissions associated with the consumption of the hydrogen fuel. That is, the “well to wheel” emissions value includes a summation of the emissions emitted to produce, transport, and consume a fuel. The amount of emissions associated with the production of the hydrogen fuel may include, for example, the amount of emissions associated with the production of electricity to power an electrolyzer, the amount of emissions associated with the acquisition of materials for producing the hydrogen, such as water for an electrolysis process or coal for a gasification process, the amount of emissions associated with refining, purifying, or processing hydrogen gases produced by an electrolysis process into hydrogen fuel, and so on. The amount of emissions associated with the transportation of the hydrogen fuel may include the amount of emissions associated with transporting hydrogen fuel from a hydrogen fuel production location to a hydrogen fueling station (e.g., emissions released by a transportation truck). The amount of emissions associated with the consumption of the hydrogen fuel may include the amount of emissions produced by an internal combustion engine when consuming the hydrogen fuel.

In some embodiments, the well to wheel emissions value is based on “well to tank emissions value.” The well to tank emissions value refers to an estimated or actual amount of emissions emitted for a fuel, such as hydrogen fuel, and may include an amount of emissions associated with the production of the hydrogen fuel, the amount of emissions associated with the transportation of the hydrogen fuel. In some embodiments, the well to tank emissions value is a summation of an amount of emissions emitted to provide the hydrogen fuel to a hydrogen storage tank coupled to a combustion engine (e.g., a hydrogen storage tank onboard a vehicle). That is, the “well to tank” emissions value includes a summation of the emissions emitted to produce and transport a fuel to a fuel storage tank onboard a vehicle. In contrast with the “well to wheel” emissions value, the “well to tank” emissions value does not include the amount of emissions associated with the consumption of the fuel in the production of work.

Based on the foregoing regarding well to wheel emissions value, a more detailed example may be with respect to hydrogen fuel as the fuel source. The well to wheel emissions value for the hydrogen fuel is based on, at least in part, a fuel source used to produce the hydrogen fuel (i.e., the fuel or fuels used to produce the hydrogen fuel itself). Classifications of hydrogen fuel may indicate the source of the hydrogen fuel. “Green hydrogen” is made by using clean electricity from surplus renewable energy sources, such as solar or wind power. The electricity is then used in an electrolysis process to produce the “green hydrogen.” “Blue hydrogen” is produced from natural gas, using a steam reforming process, which brings together natural gas and heated water in the form of steam. The output of the steam reforming process is hydrogen and carbon dioxide. The processes to produce “blue hydrogen” also includes the use of carbon capture and storage (CCS) to trap and store carbon dioxide byproducts. “Grey hydrogen” is produced from natural gas, or methane, using steam methane reformation but without capturing the greenhouse gases made in the process. Grey hydrogen is similar to blue hydrogen, but without the use of CCS. “Black hydrogen” and “brown hydrogen” are produced from black coal and brown coal, respectively. In particular, a gasification process is used to convert coal into hydrogen. “Pink hydrogen” is produced via an electrolysis process powered by nuclear energy. “Red hydrogen” is produced from biomass. Biomass can be transformed to produce hydrogen via a gasification process. Depending on the type of biomass and the use of carbon capture and storage technologies, red hydrogen can have lower CO2 emissions than grey hydrogen. “Turquoise hydrogen” is produced using a methane pyrolysis process to produce hydrogen and solid carbon. “Yellow hydrogen” is produced using an electrolysis process powered by solar energy. “White hydrogen” is a naturally occurring hydrogen.

Another well to wheel emissions value may be for electrical energy used to power an electric machine embodied in a battery electric vehicle (BEV) or hybrid vehicle. The well to wheel emissions value for the electrical energy may include/be based on an amount of emissions associated with the production, storage, and usage in an end source (e.g., electric machine) of the electrical energy. That is, the “well to wheel” emissions value includes a summation of the emissions emitted to produce, store, and use electrical energy. In some embodiments, when the electrical energy is produced from fossil fuels, the amount of emissions associated with the production of the electrical energy may include, for example, the amount of emissions associated with the acquisition of an energy source (e.g., mining coal, extracting oil or natural gas, etc.), the amount of emissions associated with consuming the energy source (e.g., burning coal, oil, natural gas, etc.) to produce the electrical energy, and so on. In some embodiments, when the electrical energy is produced from renewable sources, the amount of emissions associated with the production of the electrical energy may include, for example, a portion of the amount of emissions associated with the production of the renewable energy production device (e.g., an amount of emissions associated with producing solar panels, wind turbines, hydro-electric dams, etc.). In some embodiments, when the electrical energy is produced from nuclear power sources may include, for example, the amount of emissions associated with the acquisition of fissile material. In some embodiments, the amount of emissions associated with the storage of the electrical energy includes/is based on an estimated or actual amount of emissions emitted for the storage of the electrical energy (e.g., in a battery coupled to an electric machine). In some embodiments, the amount of emissions associated with the usage of the electrical energy (e.g., by an electric machine) includes/is based on an estimated or actual amount of emissions emitted by the usage of the electrical energy (e.g., by an electric machine). In some embodiments, the amount of emissions associated with the storage and/or use of the electrical energy is zero or negligible because, for example, the storage and use of electrical energy does not produce emissions.

In some embodiments, a “well to tank emissions value” of electrical energy includes an estimated or actual amount of emissions emitted for producing electrical energy and storing the electrical energy (e.g., in a battery coupled to an electric machine). In contrast with the “well to wheel emissions value,” the “well to tank emissions value” does not include the amount of emissions associated with the use of the electrical energy. However, because the storage and usage of electrical energy does not produce emissions, the “well to tank emissions value” of electrical energy and the “well to wheel emissions value” of the same electrical energy may have the same numeric value.

As described herein, a system may include an engine system and an exhaust aftertreatment system in exhaust gas receiving communication with the engine system. The engine system may include a hydrogen internal combustion engine (ICE) configured to combust hydrogen fuel (H₂). The engine system may include an electric machine coupled to a battery. The electric machine may be configured to consume electrical energy stored by the battery to produce power. A summation of the well to wheel emissions value associated with the hydrogen fuel and the well to wheel emissions value associated with electrical energy is referred to herein as a “well to wheel emission value associated with a system.” Advantageously, the control system may implement one or more controls to improve (e.g., reduce) the well to wheel emissions value associated with the system by, for example, reducing the well to wheel emissions value associated with the fuel, reducing the well to wheel emissions value associated with electrical energy, or both.

As described herein, “reducing” a well to wheel emissions value (e.g., the well to wheel emissions value associated with the fuel, the well to wheel emissions value associated with the electrical energy, and/or the well to wheel emissions value associated with the system) by implementing the one or more controls is relative to operating the system without implementing the one or more controls. That is, the well to wheel emissions value of the system when implementing the one or more controls is at or below the well to wheel emissions value of the system without implementing the one or more controls, for the same power output of the system.

In an example operating scenario, a system may output a first amount of power during a predefined time period (e.g., a workday, a mission of the system, etc.). When the one or more controls are not implemented during the predefined time period, the well to wheel emissions value of the system is a first value (e.g., 4000 kilograms (kg), etc.). When the one or more controls are implemented during the predefined time period, the well to wheel emissions value of the system is a second value (e.g., 3000 kg, etc.), where the second value is at or below the first value.

Based on the foregoing regarding the controls to reduce the well to wheel emissions value of a system, during operation of the system, a control system (e.g., a controller) may adjust a “power split” between the engine and the electric machine. As described herein a “power split” refers to an amount of power output by the engine (e.g., to rotate a shaft) relative to an amount of power output the electric machine (e.g., to rotate the shaft). In various embodiments, the power split of the amount of power output by the engine relative to the amount of power output the electric machine may be expressed as a numerical value, such as a ratio or a percentage value. Thus, the power split may be defined by two values: a first value indicative of the absolute or relative amount of power output by the engine and a second value indicative of the absolute or relative amount of power output by the electric machine. For example, when the amount of power output by the engine is equal to the amount of power output the electric machine, the power split is “50%-50%.” In another example, when only the electric machine is outputting power, the power split is “0%-100%.” In yet another example, when only the engine is outputting power, the power split is “100%-0%.” In other embodiments, the power split may include a single value that represents the amount of power output by the engine relative to the amount of power output the electric machine, such as a ratio or a percentage. For example, when the amount of power output by the engine is equal to the amount of power output the electric machine, the power split is “50%.” In another example, when only the electric machine is outputting power, the power split is “0%.” In yet another example, when only the engine is outputting power, the power split is “100%.”

In some embodiments, the control system or controller may adjust the power split based on, for example, a state of charge (SOC) of the battery, a target SOC of the battery, an availability of battery charging infrastructure, onboard fuel levels, fuel costs, battery charging costs, and/or other features. Advantageously and as described herein, a control system or controller may adjust the power split as a function of well to wheel emissions values associated with the hydrogen fuel and the electrical energy. In particular, the control system may adjust the power split to improve (e.g., reduce) well to wheel emission value associated with the system.

In an example embodiment, the control system may adjust and, particularly increase the power split (e.g., from a first power split value to a second power split value, greater than the first power split value), such that an amount of power output by the engine (e.g., an engine power value) increases (e.g., from a first engine power value to a second engine power value, greater than the first engine power value) and an amount of power output by the electric machine (e.g., an electric machine power value) decreases (e.g., from a first electric machine power value to a second electric machine power value, less than the first electric machine power value), responsive to the well to wheel emissions value associated with the hydrogen fuel being below the well to wheel emissions value associated with the electrical energy. For example, responsive to the well to wheel emissions value associated with the hydrogen fuel being below the well to wheel emissions value associated with the electrical energy, the control system may increase the power split, resulting in the engine power vale increasing and the electric machine power value decreasing (e.g., relative to values just before the increasing the power split). Advantageously, when the power split is increased responsive to well to wheel emissions value associated with the hydrogen fuel being below the well to wheel emissions value associated with the electrical energy, the well to wheel emissions value of the system is reduced.

In another example embodiment, the control system may adjust and, particularly decrease the power split (e.g., from a first power split value to a second power split value, less than the first power split value), such that an amount of power output by the engine decreases (e.g., from a first engine power value to a second engine power value, less than the first engine power value) and an amount of power output by the electric machine increases (e.g., from a first electric machine power value to a second electric machine power value, greater than the first electric machine power value) responsive to the well to wheel emissions value associated with the hydrogen fuel being above the well to wheel emissions value associated with the electrical energy. For example, responsive to the well to wheel emissions value associated with the hydrogen fuel being above the well to wheel emissions value associated with the electrical energy, the control system may decrease the power split, resulting in the engine power vale decreasing and the electric machine power value increasing (e.g., relative to values just before the decreasing the power split). Advantageously, when the power split is decreased responsive to well to wheel emissions value associated with the hydrogen fuel being above the well to wheel emissions value associated with the electrical energy, the well to wheel emissions value of the system is reduced.

In yet another example embodiment, the control system may implement one or more powertrain controls and/or aftertreatment controls based on comparing the well to wheel emissions value associated with the hydrogen fuel with one or more thresholds. In some embodiments, the one or more powertrain controls and/or aftertreatment controls may reduce the emissions value associated with consuming the hydrogen fuel, responsive to the well to wheel emissions value being at or above a predefined threshold. Advantageously, by reducing the emissions value associated with consuming the hydrogen fuel, the well to wheel emissions value may decrease, and, for example, may decrease below the predefined threshold. In some embodiments, the one or more powertrain controls and/or aftertreatment controls may include, for example, increasing the power split, decreasing an engine speed, adjusting (e.g., increasing or decreasing) an air-to-fuel ratio (AFR), enabling a thermal management mode to increase a temperature of the aftertreatment system and/or a component thereof (e.g., from a first temperature value to a second temperature value, greater than the first temperature value), causing a dosing module to provide a reductant to the aftertreatment system, and/or other powertrain or aftertreatment controls. In some embodiments, the controls result in a decreased amount of hydrogen fuel consumed by the powertrain (e.g., due to lower engine speeds, an increased a fuel economy value, etc.) and/or a decreased amount of emissions associated with consuming the hydrogen fuel (e.g., by increasing the amount of emissions removed by the aftertreatment system). In this way, the well to wheel emissions value associated with operating the powertrain may decrease (e.g., relative to not implementing the one or more powertrain controls and/or aftertreatment controls). These and other benefits are described more fully herein below.

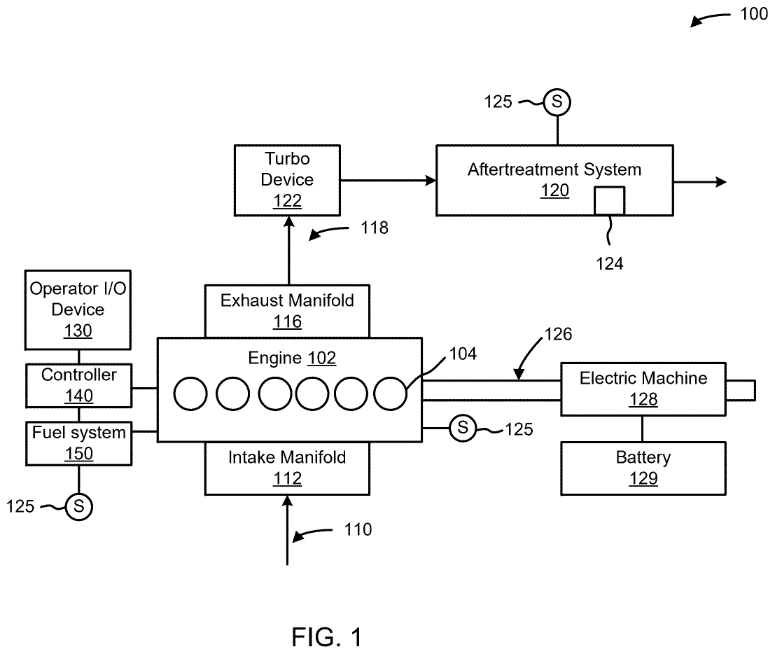

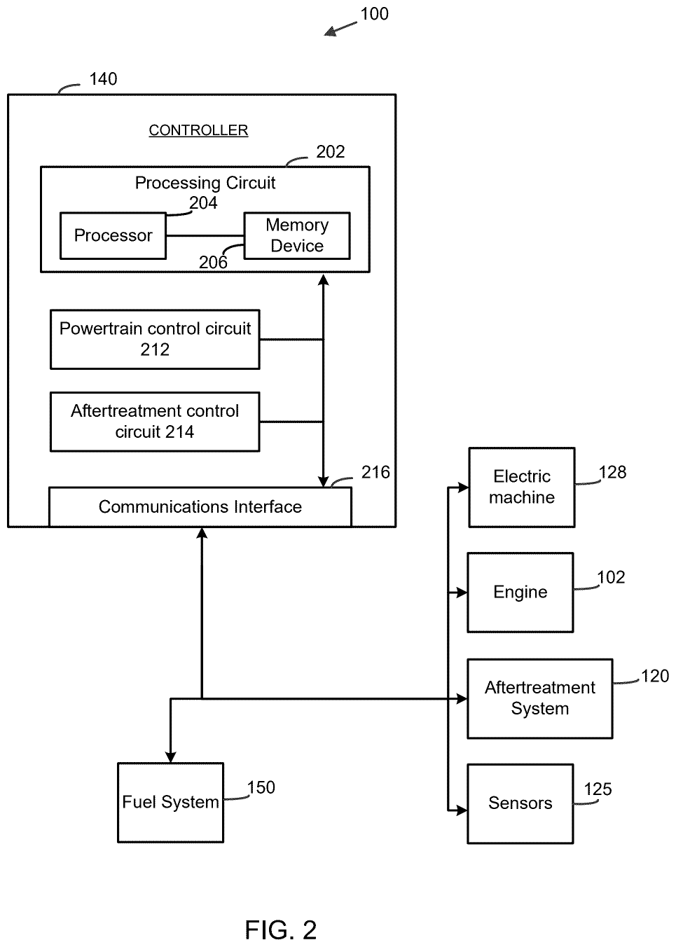

Referring now to FIG. 1, a schematic view of a block diagram of a system 100 is shown, according to an example embodiment. The system 100 includes an engine 102 and an aftertreatment system 120 in exhaust gas receiving communication with the engine 102. The system 100 includes a controller 140 (as shown in FIG. 2) and an operator input/output (I/O) device 130, where the controller 140 is communicably coupled to each of the aforementioned components.

In some embodiments, the system 100 includes a turbo device 122 disposed between the engine 102 and the aftertreatment system 120, such that the turbo device 122 is in exhaust gas receiving communication with the engine 102 and exhaust gas providing communication with the aftertreatment system 120. In these embodiments, the aftertreatment system 120 is in exhaust gas receiving communication with the engine 102 (e.g., via the turbo device 122).

In some embodiments, the system 100 is included in a vehicle. The vehicle may be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. In other embodiments, the system 100 may be embodied in a stationary piece of equipment, such as a power generator or genset. All such variations are intended to fall within the scope of the present disclosure.

In the configuration shown in FIG. 1, the engine 102 is a hydrogen internal combustion engine (ICE). The hydrogen ICE may consume hydrogen fuel to generate power. In some embodiments, the engine 102 may be part of a hybrid engine system having a combination of an internal combustion engine and at least one electric machine 128 coupled to at least one battery 129. For example, as shown in FIG. 1, the system 100 may include the electric machine 128 that is coupled to the engine 102 via a shaft 126 (e.g., an output shaft, a drive shaft, a crankshaft, etc.). In some embodiments, the system 100 may be configured as a mild-hybrid powertrain, a parallel hybrid powertrain, a series hybrid powertrain, or a series-parallel powertrain.

The engine 102 includes one or more cylinders 104 (e.g., combustion cylinders). The cylinders 104 are disposed within a combustion chamber of the engine 102. The cylinders 104 enable combustion of the hydrogen fuel within the engine 102. Combustion of hydrogen fuel causes the engine 102 to rotate, thereby causing rotation of the shaft 126.

In some embodiments, the shaft 126 may be rotated by the electric machine 128. In some embodiments, the engine 102 and the electric machine 128 may cooperate to rotate the shaft 126 concurrently or partially concurrently. In other embodiments, the engine 102 and the electric machine 128 may rotate the shaft 126 independently. That is, the engine 102 and the electric machine 128 may rotate the shaft sequentially (e.g., one after another). In these embodiments, fuel may or may not be provided to the cylinder 104 when the engine 102 is not rotating the shaft 126. In yet other embodiments, only one of the engine 102 or the electric machine 128 may rotate the shaft 126 (e.g., in a series hybrid configuration).

As shown in FIG. 1, the engine 102 includes six cylinders 104. However, it should be understood that the engine 102 may include more or fewer cylinders 104 (e.g., at least one) than as shown in FIG. 1. Furthermore, the cylinders 104 may be provided in varying arrangements (e.g., in-line, horizontal, V, or other suitable cylinder arrangement).

The system 100 includes an intake conduit 110 and an intake manifold 112. The intake conduit 110 is configured to route an intake gas stream, including air (e.g., ambient air, compressed air, etc.), to the intake manifold 112. The intake manifold 112 is configured to route the intake gas stream from an intake conduit 110 into the engine 102. More specifically, the intake manifold 112 is configured to route air from the intake conduit 110 to each of the cylinders 104.

The system 100 includes an exhaust manifold 116 and an exhaust conduit 118. The exhaust manifold 116 is configured to route an exhaust gas stream from the engine to the exhaust conduit 118. More specifically, the exhaust manifold 116 is configured to route an exhaust gas stream from each of the cylinders 104 to the exhaust conduit 118. The exhaust conduit 118 is configured to route the exhaust gas stream from the exhaust manifold 116 to a downstream component, such as the aftertreatment system 120 and/or the turbo device 122. In some embodiments, a first portion of the exhaust conduit 118 is disposed between the exhaust manifold 116 and turbo device 122. The first portion of the exhaust conduit 118 is configured to route the exhaust gas stream from the exhaust manifold 116 to turbo device 122. In some embodiments, a second portion of the exhaust conduit 118 is disposed between the aftertreatment system 120 and the turbo device 122. The second portion of the exhaust conduit 118 is configured to route the exhaust gas stream from the turbo device 122 to the aftertreatment system 120.

The aftertreatment system 120 is in exhaust gas receiving communication with the engine 102. The aftertreatment system 120 includes components used to reduce exhaust emissions, such as a selective catalytic reduction (SCR) catalyst, an oxidation catalyst (OC), a particulate filter (PF), a plurality of sensors for monitoring the aftertreatment system (e.g., a nitrogen oxide (NOx) sensor, temperature sensors, etc.), and/or still other components.

In some embodiments, the aftertreatment system 120 includes a reductant delivery system 124 (e.g., an exhaust fluid doser with a supply of exhaust fluid) which may include a decomposition chamber (e.g., decomposition reactor, reactor pipe, decomposition tube, reactor tube, etc.) to convert the reductant (e.g., urea, Adblue®, a urea water solution (UWS), an aqueous urea solution, etc.) into ammonia. The reductant delivery system 124 is configured to provide the reductant to the exhaust gas stream to aid in the catalytic reduction. The reductant may be injected by an injector upstream of the SCR catalyst member such that the SCR catalyst member receives a mixture of the reductant and exhaust gas. The reductant droplets undergo the processes of evaporation, thermolysis, and hydrolysis to form non-NOx emissions (e.g., gaseous ammonia, etc.) within the decomposition chamber, the SCR catalyst member, and/or the exhaust gas conduit system, which leaves the aftertreatment system 120.

The turbo device 122 may be any type of turbo machinery, such as a turbocharger, a variable geometry turbocharger, a power turbine, etc. The turbo device 122 may be operatively coupled to the engine 102 and/or another component of the system 100, such as a drivetrain, a battery, an electric machine, or other suitable component. In some embodiments, the turbo device 122 is configured to compress a gas stream (e.g., an intake gas stream, an exhaust gas stream, etc.) and provide the compressed gas stream to the engine 102. For example, as shown in FIG. 1, the turbo device 122 may be coupled to the intake manifold 112 such that the turbo device is operative to provide the compressed gas stream to the engine 102 (e.g., via the intake manifold 112).

In some embodiments, the system 100 includes a fuel system 150. The fuel system 150 is a system of storage tanks, conduits, pumps, filters, and other components that is configured to route a fluid, such as hydrogen fuel, to the engine 102. The fuel system 150 is coupled to the engine 102. The fuel system 150 is configured to provide the hydrogen fuel to the engine 102. The fuel system 150 is configured to receive the hydrogen fuel (e.g., from a refueling station, from a removably coupled hydrogen storage tank, etc.).

In some embodiments, the fuel system 150 includes one or more fuel tanks configured to store the hydrogen fuel. In some embodiments, the one or more fuel tanks are removable such that each fuel tank may be removed and/or replaced. For example, an empty fuel tank may be replaced with a filled or partially filled fuel tank. In some embodiments, the fuel system 150 may selectively provide the hydrogen fuel to the engine 102 from one or more of the fuel tanks. For example, the fuel system 150 may provide the hydrogen fuel to the engine 102 from a first fuel tank of the one or more fuel tanks and subsequently provide fuel to the engine 102 from a second fuel tank of the one or more fuel tanks.

As shown, a plurality of sensors 125 are included in the system 100. The number, placement, and type of sensors included in the system 100 is shown for example purposes only. That is, in other configurations, the number, placement, and type of sensors may differ. The sensors 125 may be gas constituent sensors (e.g., NOₓ sensors, oxygen sensors, H₂O/humidity sensors, hydrogen sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. In an example embodiment, the sensors 125 are configured as temperature sensors configured to acquire data regarding a temperature of a fluid, such as the fuel system 150, air at or proximate the engine 102 (e.g., at or proximate the intake manifold 112 of the engine 102), or other fluid in the system 100 and/or acquire data regarding a temperature of a component of the system 100.

As shown in FIG. 1, the sensors 125 may be located at or proximate the intake conduit the engine 102, the fuel system 150, and/or the aftertreatment system 120. It should be understood that the location of the sensors may vary, and the system 100 may include more or fewer sensors than as shown in FIG. 1.

Additional sensors may be also included with the system 100. The sensors may include engine-related sensors (e.g., torque sensors, speed sensors, pressure sensors, flowrate sensors, temperature sensors, etc.). The sensors may further include sensors associated with other components of the vehicle, such as the aftertreatment system 120, the turbo device 122, or the reductant delivery system 124. For example, the sensor may include speed sensor of the turbo device 122, a fuel quantity and injection rate sensor, fuel rail pressure sensor, etc.).

The sensors 125 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of a speed of the engine 102 (typically expressed in revolutions-per-minute). The sensor is coupled to the engine (when structured as a real sensor) and is structured to send a signal to the controller 140 indicative of the speed of the engine 102. When structured as a virtual sensor, at least one input may be used by the controller 140 in an algorithm, model, lookup table, etc. to determine or estimate a parameter of the engine (e.g., power output, etc.). Any of the sensors 125 described herein may be real or virtual.

The controller 140 is coupled, and particularly communicably coupled, to the sensors 125. Accordingly, the controller 140 is structured to receive data from one or more of the sensors 125 and provide instructions/information to the one or more sensors 125. The controller 140 may use the received data to control one or more components in the system 100 as described herein.

As briefly described above, the system 100 includes a shaft 126. In an example embodiment, the shaft 126 is a crankshaft. In other embodiments, the shaft 126 may be any shaft coupled directly or indirectly to the engine 102 such that the shaft is rotated by the engine 102. For example, the shaft 126 may be an output shaft, a drive shaft, a crankshaft, or other suitable shaft. The shaft 126 is configured to transmit power output by the engine 102 to another component, such as an axle, a wheel, or another shaft. In some embodiments, an intermediate component couples the engine 102 to the shaft 126, such as a clutch, a transmission, etc.

As briefly described above, the system 100 includes the electric machine 128. In some embodiments, the electric machine 128 is a motor, a motor generator, an electric starter, an eAxle, or other type of electric machine. Further, multiple electric machines 128 may be included in the system in some embodiments. And, the electric machines may be of different structures (e.g., a motor and a motor generator). As briefly described above, the system 100 may be configured as or include a hybrid powertrain where the engine 102 and the electric machine 128 cooperate to define the hybrid powertrain. The hybrid powertrain may be configured as a mild-hybrid powertrain, a parallel hybrid powertrain, a series hybrid powertrain, or a series-parallel powertrain. The electric machine 128 is configured to use electrical power (e.g., from a battery) to output mechanical power. For example, the electric machine 128 is coupled to the shaft 126 such that the shaft 126 is operable to receive power output by the electric machine 128. In this way, the electric machine 128 is operable to rotate shaft 126. In some embodiments, the system 100 includes a battery 129. The electric machine 128 is coupled to the battery 129 such that the electric machine 128 is operable to provide power to and/or receive power from the battery 129. The electric machine 128 may be rotated by shaft 126 such that the electric machine 128 generates power (e.g., electrical power). For example, the shaft 126 may be rotated by the engine 102 (as described above) and/or by a regenerative braking process whereby energy captured from braking causes the shaft to rotate. The electric machine 128 may provide the generated power to the battery 129 (e.g., to charge the battery). In another example, the electric machine 128 may receive power from the battery 129 and consume the power to rotate the shaft 126.

The operator input/output (I/O) 130 device may be coupled to the controller 140, such that information may be exchanged between the controller 140 and the I/O device, where the information may relate to one or more components of FIG. 1 or determinations (described below) of the controller 140. The operator I/O device enables an operator of the system 100 to communicate with the controller 140 and one or more components of the system 100 of FIG. 1. For example, the operator input/output device may include, but is not limited to, an interactive display, a touchscreen device, one or more buttons and switches, voice command receivers, etc. In this way, the operator input/output device may provide one or more indications or notifications to an operator, such as a malfunction indicator lamp (MIL), etc. Additionally, the vehicle may include a port that enables the controller 140 to connect or couple to a scan tool so that fault codes and other information regarding the vehicle may be obtained.

The controller 140 is structured to control, at least partly, the operation of the system 100 and associated sub-systems, such as the engine 102 and the operator I/O device 130. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1. The structure and function of the controller 140 is further described in regard to FIG. 2.

As the components of FIG. 1 are shown to be embodied in the system 100, the controller 140 may be structured as one or more electronic control units (ECUs), such as one or more microcontrollers. The controller 140 may be separate from or included with at least one of a transmission control unit, an exhaust aftertreatment control unit, a powertrain control module, an engine control unit, an engine control module, etc.

In other embodiments of the system 100, one or more components or systems of the system 100 shown in FIG. 1 may be omitted.

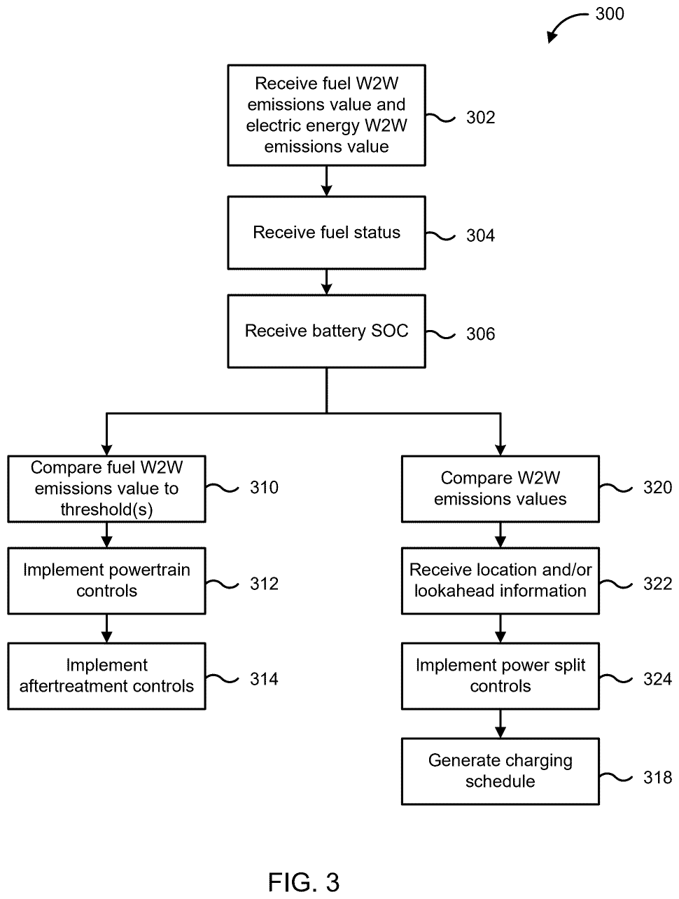

Now referring to FIG. 2, a schematic diagram of the controller 140 of the system 100 of FIG. 1 is shown, according to an example embodiment. As shown, the controller 140 includes at least one processing circuit 202 having at least one processor 204 and at least one memory device 206, a powertrain control circuit 212, an aftertreatment control circuit 214, and a communications interface 216. The controller 140 is structured to control operation of the other components of the system 100. In some embodiments, the controller 140 may control operation of the fuel system 150, the engine 102, the electric machine 128, and/or other components of the system 100 to achieve a desired or target well to wheel emissions value. For example, the controller 140 may operate one or more valves, motors, actuators, heaters, or other suitable devices to achieve the target well to wheel emissions value. An example method for controlling the components of the system 100 is described herein with respect to FIG. 3.

In one configuration, the powertrain control circuit 212 and/or the aftertreatment control circuit 214 are embodied as machine or computer-readable media storing instructions that are executable by a processor, such as processor 204. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the powertrain control circuit 212 and/or the aftertreatment control circuit 214 are embodied as hardware units, such as one or more electronic control units. As such, the powertrain control circuit 212 and/or the aftertreatment control circuit 214 may be embodied as one or more circuitry components including, but not limited to, processing circuitry, network interfaces, peripheral devices, input devices, output devices, sensors, etc. In some embodiments, the powertrain control circuit 212 and/or the aftertreatment control circuit 214 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the powertrain control circuit 212 and/or the aftertreatment control circuit 214 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The powertrain control circuit 212 and/or the aftertreatment control circuit 214 may also include or be programmable hardware devices such as field programmable gate arrays, programmable array logic, programmable logic devices or the like. The powertrain control circuit 212 and/or the aftertreatment control circuit 214 may include one or more memory devices for storing instructions that are executable by the processor(s) of the powertrain control circuit 212 and/or the aftertreatment control circuit 214. The one or more memory devices and processor(s) may have the same definition as provided below with respect to the memory device 206 and processor 204. In some hardware unit configurations, the powertrain control circuit 212 and/or the aftertreatment control circuit 214 may be geographically dispersed throughout separate locations in the vehicle. Alternatively, and as shown, the powertrain control circuit 212 and/or the aftertreatment control circuit 214 may be embodied in or within a single unit/housing, which is shown as the controller 140.

In the example shown, the controller 140 includes the at least one processing circuit 202 having the at least one processor 204 and the at least one memory device 206. The processing circuit 202 may be structured or configured to execute or implement the instructions, commands, and/or control processes described herein with respect to the powertrain control circuit 212 and/or the aftertreatment control circuit 214. The depicted configuration represents the powertrain control circuit 212 and/or the aftertreatment control circuit 214 as being embodied as machine or computer-readable media storing instructions (which may be stored by the memory device 206). However, as mentioned above, this illustration is not meant to be limiting as the present disclosure contemplates other embodiments where the powertrain control circuit 212 and/or the aftertreatment control circuit 214 is configured as a hardware unit. All such combinations and variations are intended to fall within the scope of the present disclosure.

The at least one processor 204 may be implemented as one or more single-or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the powertrain control circuit 212 and/or the aftertreatment control circuit 214 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 206 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 206 may include dynamic random-access memory (DRAM). The memory device 206 may be communicably connected to the processor 204 to provide computer code or instructions to the processor 204 for executing at least some of the processes described herein. Moreover, the memory device 206 may be or include tangible, non-transient volatile memory, or non-volatile memory. Accordingly, the memory device 206 may include database components, object code components, script components, or any other type of information structure for supporting the various activities and information structures described herein.

The communications interface 216 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server) (when the system 100 is embodied within a vehicle). For example, and regarding out-of-vehicle/system communications, the communications interface 216 may include an Ethernet card and port for sending and receiving data via an Ethernet-based communications network and/or a Wi-Fi transceiver for communicating via a wireless communications network. The communications interface 216 may be structured to communicate via local area networks or wide area networks (e.g., the Internet) and may use a variety of communications protocols (e.g., IP, LON, Bluetooth, ZigBee, radio, cellular, near field communication).

As shown in FIG. 2, the communications interface 216 may enable communication with the engine 102, the aftertreatment system 120 (and/or a component thereof), the one or more sensors 125, the fuel system 150, and/or the electric machine 128.

The powertrain control circuit 212 is structured to enable or implement one or more powertrain controls. In some embodiments, the one or more powertrain controls include adjusting the power split between the engine 102 and the electric machine 128.

In some embodiments, the controller 140 and/or a component thereof, such as the powertrain control circuit 212, may adjust the power split based on a state of charge (SOC) of the battery 129 compared to a target SOC of the battery 129. For example, the controller 140 may increase the power split (e.g., such that more power is provided to the shaft 126 by the engine 102 relative to the electric machine 128) responsive to the SOC of the battery 129 being at or below the target SOC and/or at or below a predefined threshold. In another example, the controller 140 may decrease the power split (e.g., such that more power is provided to the shaft 126 by the electric machine relative to the engine 102) responsive to the SOC of the battery 129 being above the target SOC and/or above a predefined threshold.

In some embodiments, the controller 140 and/or a component thereof, such as the powertrain control circuit 212, may adjust the power split based on an availability of battery charging infrastructure. For example, the controller 140 may receive lookahead data. The “lookahead” data relates to information regarding upcoming conditions of the system 100. In some embodiments, when the system 100 is embodied in a vehicle, the lookahead data may relate to information regarding upcoming road conditions. For example, the lookahead data may include data relating to road conditions or other parameters sensed within a predefined distance ahead of the current location of the vehicle. The lookahead data may include information regarding the path of a vehicle, such as a road grade, a speed limit, street or highway names, turn-by-turn directions, locations of refueling stations on or within a predetermined distance of the path, locations of charging stations on or within a predetermined distance of the path, rest stops and/or other information regarding the path. The controller 140 may increase the power split (e.g., such that more power is provided to the shaft 126 by the engine 102 relative to the electric machine 128) responsive to the lookahead data indicating that the nearest charging station is further than a predetermined distance away from the system 100. In another example, the controller 140 may decrease the power split (e.g., such that more power is provided to the shaft 126 by the electric machine relative to the engine 102) responsive to the lookahead data indicating that the nearest charging station is within a predetermined distance away from the system 100.

In some embodiments, the controller 140 and/or a component thereof, such as the powertrain control circuit 212, may adjust the power split based on onboard fuel levels (e.g., an amount of fuel stored by the fuel system 150). The controller 140 may increase the power split (e.g., such that more power is provided to the shaft 126 by the engine 102 relative to the electric machine 128) responsive to the amount of fuel stored by the fuel system 150 being at or above a predetermined threshold. In another example, the controller 140 may decrease the power split (e.g., such that more power is provided to the shaft 126 by the electric machine relative to the engine 102) responsive to the amount of fuel stored by the fuel system 150 being below a predetermined threshold.

In some embodiments, the controller 140 and/or a component thereof, such as the powertrain control circuit 212, may adjust the power split based on at least one of an onboard fuel level (e.g., an amount of fuel stored by the fuel system 150), an expected fuel cost, and/or an expected battery charging cost relative to a corresponding threshold value. The lookahead data may include information regarding an expected fuel cost and/or an expected battery charging cost at a fueling station and/or recharging station that is within a predetermined distance of the path of the system 100 and/or within a predetermined distance of the system 100. The expected fuel cost may be based on a cost per unit of fuel at the fueling station and a desired amount of fuel, such that the expected cost is the cost per unit of fuel multiplied by the desired amount of fuel. In some embodiments, the controller 140 may receive the cost per unit fuel from a remote computing system associated with the fueling station or another service provider. In other embodiments, the controller 140 may receive the cost per unit fuel via a user input. In an example embodiment, if the cost per unit of fuel is $10 per kilogram of hydrogen, and the desired amount of fuel is 2 kilograms of hydrogen, the expected fuel cost is $20. Similarly, the expected battery charging cost at a recharging station is the cost per unit of energy multiplied by the desired amount of energy. In some embodiments, the controller 140 may receive the cost per unit of energy from a remote computing system associated with the fueling station or another service provider. In other embodiments, the controller 140 may receive the cost per unit of energy via a user input. In an example embodiment, if the cost per unit of energy is $1 per kilowatt-hour (kWh), and the desired amount of energy is 20 kWh, the expected battery charging cost is $20. The controller 140 may increase the power split (e.g., such that more power is provided to the shaft 126 by the engine 102 relative to the electric machine 128) responsive to the expected fuel cost being at or below a predetermined threshold and/or responsive to the expected battery charging cost being at or above a predetermined threshold. In another example, the controller 140 may decrease the power split (e.g., such that more power is provided to the shaft 126 by the electric machine relative to the engine 102) responsive to the expected fuel cost being at or above a predetermined threshold and/or responsive to the expected battery charging cost being at or below a predetermined threshold.

In some embodiments, the controller 140 may adjust the power split as a function of well to wheel emissions values associated with the hydrogen fuel and the electrical energy. In particular, the controller 140 may adjust the power split to improve (e.g., reduce) well to wheel emission values associated with the system. In some embodiments, the controller 140 may receive information regarding the well to wheel emissions value for the hydrogen fuel stored in the fuel system 150 and the well to wheel emissions value for electrical energy stored by the battery 129 and adjust the power split based on these values.

In some embodiments, the received well to wheel emissions value for the hydrogen fuel stored in the fuel system 150 is an “estimated” well to wheel emissions value for the hydrogen fuel stored in the fuel system 150. The “estimated” well to wheel emissions value is a calculated value that is based on the current operating conditions of the engine 102 (e.g., current engine operating conditions) and/or current operating conditions of the aftertreatment system 120 (e.g., current aftertreatment system operating conditions), without directly measuring the amount of emissions emitted by consuming the hydrogen fuel. In an example embodiment, the estimated well to wheel emissions value for the hydrogen fuel stored in the fuel system 150 may be based on an estimated “tank to wheel” emissions value of the hydrogen fuel. The estimated “tank to wheel” emissions value of the hydrogen fuel may be an estimated amount of emissions produced by consuming the fuel, based on, for example, current engine operating conditions, current aftertreatment system operating conditions, and/or other suitable parameters regarding the operation of the system 100. The estimated well to wheel emissions value of the hydrogen fuel may be determined based on a summation of the well to tank emissions value of the hydrogen fuel stored in the fuel system 150 and the estimated tank to wheel emissions value of the hydrogen fuel.

In some embodiments, the received well to wheel emissions value for the hydrogen fuel is an “actual” well to wheel emissions value for the hydrogen fuel. The controller 140 may receive the amount of emissions emitted by the aftertreatment system 120 from one or more sensors 125. The controller 140 may determine the actual well to wheel emissions value based on a summation of the well to tank emissions value and an actual tank to wheel emissions value. The actual tank to wheel emissions value is the amount of emissions emitted by the aftertreatment system 120. It should be understood that, in any of the embodiments described herein, the well to wheel emissions value for the hydrogen fuel may be the estimated well to wheel emissions value for the hydrogen fuel or the actual well to wheel emissions value for the hydrogen fuel, unless otherwise noted.

In some embodiments, the controller 140 may increase the power split, such that an amount of power output by the engine 102 (e.g., an engine power value) increases and an amount of power output by the electric machine 128 (e.g., an electric machine power value) decreases, when the well to wheel emissions value associated with the hydrogen fuel is less than the well to wheel emissions value associated with the electrical energy. As a result of the change in the power split, a greater portion of the power output by the system 100 originates from an energy source having a lower well to wheel emissions value. In this case, the energy source having the lower well to wheel emissions value is the hydrogen fuel. In this way, the well to wheel emission value associated with the system 100 is reduced.

In another example embodiment, the controller 140 may decrease the power split, such that the amount of power output by the engine decreases and the amount of power output by the electric machine increases, when the well to wheel emissions value associated with the hydrogen fuel is greater than the well to wheel emissions value associated with the electrical energy. As a result of the change in the power split, a greater portion of the power output by the system 100 originates from an energy source having a lower well to wheel emissions value. In this case, the energy source having the lower well to wheel emissions value is the electrical energy. In this way, the well to wheel emission values associated with the system 100 is reduced.

In some embodiments, the controller 140 and/or a component thereof, such as the powertrain control circuit 212, may adjust the power split based on the estimated well to wheel emissions value of hydrogen fuel that is available to the system 100 and/or the well to wheel emissions value of electrical energy that is available to the system 100. For example, the lookahead information may include information regarding the estimated well to wheel emissions value of hydrogen fuel that is available to the system 100. The hydrogen fuel that is available to the system 100 may include hydrogen at a refueling station that is within a predetermined distance of a route of the system 100 and/or within a predetermined distance of the system 100. The electrical energy that is available to the system 100 may include electrical energy at a recharging station that is within a predetermined distance of a route of the system 100 and/or within a predetermined distance of the system 100. The controller 140 may increase the power split (e.g., such that more power is provided to the shaft 126 by the engine 102 relative to the electric machine 128) responsive to the lookahead data indicating that the well to wheel emissions value of the electrical energy available to the system 100 is at or above a predetermined threshold. In another example, the controller 140 may decrease the power split (e.g., such that more power is provided to the shaft 126 by the electric machine relative to the engine 102) responsive to the lookahead data indicating that the well to wheel emissions value of the hydrogen fuel available to the system 100 is at or above a predetermined threshold.

In some embodiments, the lookahead information may also include an indication of a schedule of the system 100, such as indications of planned downtime (e.g., a lunch break, arriving at a destination, parking at a location overnight, etc.), and so on. The controller 140 may determine a charging schedule for the battery 129 based on the planned downtime and the well to wheel emissions value of the electrical energy available to the system 100. For example, the controller 140 may direct an operator of the system 100 to recharge the battery 129 at a charging location based on the well to wheel emissions value of the electrical energy available at the charging location being at or below a predetermined threshold and an estimated time of arrival at the charging location being within a predetermined threshold of the planned downtime.

In some embodiments, the controller 140 and/or a component thereof, such as the powertrain control circuit 212, may adjust the power split based on a location of the system 100, the estimated well to wheel emissions value of hydrogen fuel, and the well to wheel emissions value of electrical energy. For example, the lookahead information may include information regarding restrictive emissions areas. The restrictive emissions areas may be regions, territories, states, or other geographic areas that restrict (e.g., limit) the well to wheel emissions value of vehicles operating within the restrictive emissions area. The controller 140 may increase the power split (e.g., such that more power is provided to the shaft 126 by the engine 102 relative to the electric machine 128) responsive to the system 100 entering the restrictive emissions area and responsive to the well to wheel emissions value of the electrical energy being at or above a predetermined threshold corresponding to the restrictive emissions area. In another example, the controller 140 may decrease the power split (e.g., such that more power is provided to the shaft 126 by the electric machine relative to the engine 102) responsive to the system 100 entering the restrictive emissions area and responsive to the well to wheel emissions value of the hydrogen fuel being at or above a predetermined threshold corresponding to the restrictive emissions area. In this way, as the system 100 enters an area with more restrictive emissions (e.g., based on a GPS location of the system 100 GPS, a geo-fenced area, etc.), the controller 140 may adjust the power split.

In some embodiments, the one or more powertrain controls include adjusting one or more operating parameters of the engine 102. In some embodiments, the powertrain controls include adjusting one or more engine operating parameters to reduce an emissions value associated with consuming the hydrogen fuel, responsive to determining that the well to wheel emissions value associated with the hydrogen fuel is at or above a first predetermined threshold. The first predefined threshold may be a predefined well to wheel emissions value, such as a target well to wheel emissions value. When the well to wheel emissions value associated with the hydrogen fuel is at or above the first predefined threshold, it may be desirable to decrease the well to wheel emissions value because being above the threshold indicates more unwanted emissions than desired. Adjusting one or more engine operating parameters to reduce an emissions value associated with consuming the hydrogen fuel may include, for example, adjusting a fuel injection timing, adjusting a fuel injection quantity (e.g., to change an air-to-fuel ratio to be closer to a stoichiometric ratio), adjusting a spark timing, adjusting a wastegate or variable geometry turbocharger position, actuating a charge air cooler bypass valve, adjusting an intake air quantity (e.g., to change an air-to-fuel ratio to be closer to a stoichiometric ratio), adjusting an exhaust gas recirculation amount, adjusting an effective compression ratio, and so on. In this way, implementing the one or more powertrain controls may decrease the well to wheel emissions value regarding the fuel by decreasing the tank to wheel emissions value of the fuel.

In some embodiments, the powertrain controls include adjusting one or more engine operating parameters to increase a fuel economy value associated with consuming the hydrogen fuel, responsive to determining that the estimated well to wheel emissions value associated with the hydrogen fuel is at or below a second predetermined threshold. The second predefined threshold may be a predefined well to wheel emissions value, such as a target well to wheel emissions value. When the well to wheel emissions value associated with the hydrogen fuel is at or below the second predefined threshold, it may be desirable to increase the fuel economy of the engine 102, even at the expense of increasing the well to wheel emissions value of the hydrogen fuel, because being below the second predefined threshold indicates that the system 100 could emit more emissions before the system 100 emits an undesirable amount of emissions.

In some embodiments, when the engine 102 and the electric machine 128 are configured as a series hybrid powertrain or a series-parallel hybrid powertrain, the one or more powertrain controls include adjusting an engine on/off point. The engine on/off point refers to a setpoint that is used to selectively enable combustion in the engine 102. When a corresponding parameter value is below the engine on/off point (e.g., the setpoint), combustion in the engine 102 is enabled, such that the engine 102 consumes hydrogen fuel and produces electrical energy (e.g., via an alternator, a motor generator, an inverter, and/or other suitable component(s)). When the corresponding parameter value is at or above the engine on/off point, combustion in the engine 102 is disabled, such that the engine 102 does not consume hydrogen fuel. In some embodiments, the engine on/off point is a predetermined value. In an example embodiment, the engine on/off point can be a target SOC value for the battery 129. The corresponding parameter value can be a current SOC value of the battery 129. In another example embodiment, the engine on/off point is based on the lookahead data indicating an upcoming regenerative braking opportunity, such as an upcoming road grade that is at or below a predetermined threshold or a decrease in speed limit that is at or above a predetermined threshold. In particular, the engine on/off point can be a target amount of energy generated by the regenerative braking opportunity. The corresponding parameter can be an expected amount of energy generated by the upcoming regenerative braking opportunity.

In some embodiments, the powertrain controls include decreasing the engine on/off point, responsive to determining that the well to wheel emissions value associated with the hydrogen fuel is at or above a first predetermined threshold. The first predefined threshold may be a predefined well to wheel emissions value, such as a target well to wheel emissions value. When the well to wheel emissions value associated with the hydrogen fuel is at or above the first predefined threshold, it may be desirable to decrease the well to wheel emissions value because being above the threshold indicates more unwanted emissions than desired. Decreasing the engine on/off point may reduce an emissions value associated with consuming the hydrogen fuel by, for example, reducing the amount of hydrogen fuel consumed by the engine 102.

In some embodiments, the powertrain controls include increasing the engine on/off point, responsive to determining that the well to wheel emissions value associated with the electrical energy is at or above a second predetermined threshold. In some embodiments, the second predetermined threshold is the same as the first predetermined threshold. In other embodiments, the predetermined threshold is the well to wheel emissions value associated with the hydrogen fuel. When the well to wheel emissions value associated with the electrical energy is at or above the second predefined threshold, it may be desirable to decrease the well to wheel emissions value because being above the threshold indicates more unwanted emissions than desired. Increasing the engine on/off point may reduce an emissions value associated with using the electrical energy by, for example, using the hydrogen fuel to generate electrical energy, such that the well to wheel emissions value of the electrical energy decreases because the hydrogen fuel used to generate the electrical energy has a lower well to wheel emissions value than the electrical energy stored by the battery 129. In this way, implementing the one or more powertrain controls may decrease the well to wheel emissions value regarding the electrical energy by decreasing the well to tank emissions value of the electrical energy.

The aftertreatment control circuit 214 enables or implements one or more aftertreatment controls. In some embodiments, the one or more aftertreatment controls may include operating and/or adjusting one or more components of the aftertreatment system 120 and/or the engine 102. In some embodiments, the one or more aftertreatment controls includes a thermal management mode. As an example, and during the thermal management mode, the controller 140 may provide commands to increase an exhaust gas temperature to increase the temperature of one or more components in the aftertreatment system 120 (e.g., via higher engine power outputs, implementing a cylinder deactivation mode, causing a heater, such as a grid heater, an electric heater, etc., to heat the exhaust gas, adjusting a variable geometry turbocharger to increase a gas pressure, etc.). In an example embodiment, the controller 140 may implement a thermal management mode based on the estimated well to wheel emissions value of the hydrogen fuel being at or above a predefined threshold. Advantageously, implementing the thermal management mode may increase the efficiency (e.g., a ratio of converted emissions to total emissions) of the aftertreatment system 120, thereby reducing the well to wheel emissions value of the fuel.

In some embodiments, the one or more aftertreatment controls include adjusting one or more operating parameters of the aftertreatment system 120. For example, the one or more aftertreatment controls may include causing the reductant delivery system 124 to increase an amount of reductant provided to the aftertreatment system 120, responsive to determining that the well to estimated wheel emissions value is at or above a predefined threshold. In another example, the one or more aftertreatment controls may include causing the reductant delivery system 124 to decrease the amount of reductant provided to the aftertreatment system 120, responsive to determining that estimated the well to wheel emissions value is at or below a predefined threshold.

In some embodiments, the controller 140 may implement one or more aftertreatment controls and/or one or more powertrain controls based on a well to wheel emissions value regarding a fuel stored by the fuel system 150. For example, the controller 140 may receive a well to wheel emissions value regarding the fuel stored at the fuel system 150. The controller 140 may compare the well to wheel emissions value to the first predefined threshold and/or the second predefined threshold. The controller 140 may implement one or more aftertreatment controls based on the comparison. For example, the controller 140 may cause the reductant delivery system 124 to provide a first amount of reductant to the aftertreatment system 120, responsive to the well to wheel emissions value being at or above the first threshold. The controller 140 may cause the reductant delivery system 124 to provide a second amount of reductant, less than the first amount, to the aftertreatment system 120, responsive to the well to wheel emissions value being at or below the second threshold. The controller 140 may cause the reductant delivery system 124 to provide a third amount of reductant, less than the first amount, but more than the second amount, to the aftertreatment system 120, responsive to the well to wheel emissions value being above the second threshold, but below the first threshold.

The controller 140 may implement one or more powertrain controls based on the comparison. For example, the controller 140 may set a power split to a first power split value (e.g., 0%, 25%, 30%, etc.), responsive to the well to wheel emissions value being at or above the first threshold. The controller 140 may set the power split to a second power split value (e.g., 75%, 80%, 100%, etc.), greater than the first power split value, responsive to the well to wheel emissions value being at or below the second threshold. The controller 140 may set the power split to a third power split value (e.g., 40%, 50%, 60%, etc.), greater than the first power split value, but less than the second power split value, responsive to the well to wheel emissions value being above the second threshold, but below the first threshold. In any of the above-described embodiments, setting the power split value includes causing the engine 102 and the electric machine 128 to output power according to the power split value. For example, if the power split value is set to 80%, the controller 140 causes the engine 102 to output 80% of the power output by the system 100, and the controller 140 causes the electric machine 128 to output 20% of the power output by the system 100.

In any of the above-described embodiments, when the system 100 refuels (e.g., receives additional hydrogen fuel) or switches to a different on-board tank with a different type of hydrogen, the controller 140 may recalculate the estimated well to wheel emissions value associated with the hydrogen fuel. Similarly, when the system 100 recharges (e.g., receives electrical energy from a charging station) the controller 140 may recalculate the estimated well to wheel emissions value associated with the electrical energy.

In any of the above-described embodiments, the hydrogen fuel and electrical energy may be replaced with other types of fuel. In an example embodiment, the system 100 may be configured as a multi-fuel system configured to consume at least two types of fuel including, for example, hydrogen fuel, biodiesel, diesel, gasoline, natural gas, propane, and so on. Thus, it should be understood that the various examples described herein may be utilized with a multi-fuel system configured to consume at least two types of fuel.

Now referring to FIG. 3, a flow diagram of a method 300 of enabling one or more aftertreatment controls and/or one or more powertrain controls is shown, according to an example embodiment. In particular, the controller 140, or a component thereof such as the powertrain control circuit 212 and/or the aftertreatment control circuit 214, is structured to enabling and/or implement one or more aftertreatment controls and/or one or more powertrain controls. As described above, enabling and/or disabling one or more aftertreatment controls and/or one or more powertrain controls may be based on a well to wheel emissions value of a fuel (e.g., hydrogen fuel) stored by the fuel system 150 or a well to wheel value of electrical energy stored by the battery 129. It should be understood that certain of the method 300 processes may be combined in other embodiments; implemented in a different order than depicted in other embodiments; and, in some embodiments, certain of the method 300 processes may be deleted/omitted.

At process 302, the controller 140 receives a well to wheel emissions value regarding the fuel (e.g., a first well to wheel emissions value, a fuel W2W emissions value) and a well to wheel emissions value regarding the electrical energy (e.g., a second well to wheel emissions value, an electrical energy W2W emissions value). In some embodiments, the well to wheel emissions value regarding the fuel may include an actual well to tank emissions value of the fuel and an estimated or actual tank to wheel emissions value. In some embodiments, the well to wheel emissions value regarding the electrical energy may include an actual well to tank emissions value of the electrical energy.

At process 304, the controller 140 receives a fuel status. In some embodiments, the fuel status is a fuel status value regarding an amount of fuel stored by the fuel system 150. In some embodiments, the fuel status is indicative of a characteristic of the fuel, such as a fuel type (e.g., green hydrogen, brown hydrogen, etc.). The characteristic of the fuel may also include an indication of a blended fuel type (e.g., when the fuel system 150 stores fuel of more than one type). The indication of the blended fuel type may indicate an amount (e.g., an absolute amount, such as a mass or volume and/or a relative amount, such as a percentage of a total amount of fuel) of each of the fuel types stored by the fuel system 150. For example, the indication of the blended fuel type may include a first value indicative of a percentage of the fuel stored by the fuel system 150 that is a first fuel type (e.g., 40% green hydrogen) and a second value indicative a percentage of fuel stored by the fuel system 150 that is a second fuel type (e.g., 60% pink hydrogen).

At process 306, the controller 140 receives a battery state of charge (SOC) value. The battery SOC value is indicative of an amount of electrical energy stored by the battery 129. In some embodiments, the battery SOC value is expressed as a percentage of a maximum charge of the battery 129. In some embodiments, the battery SOC value is expressed as a measurement of electrical energy stored by the battery (e.g., kilowatt-hours, etc.). In some embodiments, the battery SOC value is expressed as a range of the system 100 using the electrical energy stored by the battery 129 (e.g., 150 miles, etc.). In some embodiments, the method 300 may proceed to process 310 and/or process 320. In some embodiments, process 310 (and subsequent processes thereof) and process 320 (and subsequent processes thereof) may be performed concurrently, partially concurrently, or sequentially.

At process 310, the controller 140 compares the well to wheel emissions values (e.g., one or both of the well to wheel emissions value regarding the fuel or the well to wheel emissions value regarding the electrical energy) to one or more thresholds. For example, the controller 140 may compare a first well to wheel emissions value (e.g., the well to wheel emissions value regarding the fuel) to one or more thresholds (e.g., a first threshold, a second threshold, etc.). In some embodiments, the first threshold and/or the second threshold is based on a target emissions value that is defined by a regulation (e.g., a limit set by a government agency) or a goal (e.g., a desired emissions value set by a business or operator of the system 100).

In some embodiments, the controller 140 compares a characteristic of the fuel stored by the fuel system 150, such as the fuel type (e.g., green hydrogen, brown hydrogen, etc.), to one or more predetermined fuel types (e.g., green hydrogen, pink hydrogen, etc.).

At process 312, the controller 140 may implement one or more powertrain controls. In some embodiments, the controller 140 may implement one or more powertrain controls based on comparing the first well to wheel emissions value to the first threshold and/or the second threshold. In some embodiments, the controller 140 may implement one or more powertrain controls including adjusting one or more engine operating parameters to reduce an emissions value associated with consuming the hydrogen fuel, responsive to the first well to wheel emissions value being at or above the first threshold. In some embodiments, the controller 140 may implement one or more powertrain controls including adjusting one or more engine operating parameters to increase a fuel economy value associated with consuming the hydrogen fuel, responsive to determining that the first well to wheel emissions value is at or below the second threshold.

In some embodiments, implementing the powertrain controls includes adjusting a “transmission shift schedule” for the engine 102. The “transmission shift schedule” may define a relationship between an input value, such as an operating characteristic of the engine 102 (e.g., engine speed, engine load, engine torque, etc.), a pedal position (which may be expressed as a percentage), and so on, with a transmission gear setting (e.g., first gear, second gear, neutral, etc.). Responsive to the well to wheel emissions value being at or above the first threshold, the controller 140 may increase the gear setting (e.g., changing from first gear to second gear, changing from second gear to third gear, etc.). More specifically, the controller 140 may adjust the transmission shift schedule such that an input value (e.g., an engine torque value) corresponds to relatively higher gear settings for a predefined pedal position. For example, during normal operation, when the pedal position is at 50%, the transmission shift schedule causes a change in the gear setting from the first gear to the second gear when the engine torque value increases above 10 newton-meters (Nm). After adjusting the transmission shift schedule, when the pedal position is at 50%, the adjusted transmission shift schedule causes a change in the gear setting from the first gear to the second gear when the engine torque value increases above 8 newton-meters (Nm).

In some embodiments, the controller 140 may implement one or more powertrain controls based on comparing the characteristic of the fuel stored by the fuel system 150 (e.g., the fuel type) to one or more predetermined fuel types. Each of the predetermined fuel types may correspond to one or more powertrain controls. When the characteristic of the fuel stored by the fuel system 150 matches a predetermined fuel type, the controller 140 may implement the corresponding powertrain controls. For example, when the fuel stored by the fuel system 150 is a first fuel type, the controller 140 may implement one or more powertrain controls that correspond to the first fuel type, and when the fuel stored by the fuel system 150 is a second fuel type, the controller 140 may implement one or more powertrain controls that correspond to the second fuel type. In some embodiments, when the fuel type is a blended fuel type, the controller 140 may implement the one or more powertrain controls corresponding to any of the fuel types in the blended fuel type. For example, when the blended fuel type includes a first type of fuel and a second type of fuel, the controller 140 may implement the one or more powertrain controls corresponding to the first type of fuel or the one or more powertrain controls corresponding to the second type of fuel. In some embodiments, the controller 140 may implement the one or more powertrain controls corresponding to the fuel type having a higher well to tank emissions value.

At process 314, the controller 140 may implement one or more aftertreatment controls. In some embodiments, implementing the one or more aftertreatment controls includes implementing a thermal management mode. For example, the controller 140 may implement a thermal management mode based on the first well to wheel emissions value being at or above the first threshold.

In some embodiments, implementing the aftertreatment controls includes adjusting the operation of the reductant delivery system 124. For example, the controller 140 may cause the reductant delivery system 124 to increase an amount of reductant provided to the aftertreatment system 120, responsive to determining that the first well to wheel emissions value is at or above the first threshold. In another example, the controller 140 may cause the reductant delivery system 124 to decrease the amount of reductant provided to the aftertreatment system 120, responsive to determining that the first well to wheel emissions value is at or below the second threshold.

In some embodiments, implementing the aftertreatment controls includes adjusting a flow of the exhaust within the aftertreatment system 120. For example, the controller 140 may cause the exhaust gas to flow through one or more catalyst members of the aftertreatment system 120 and/or the controller 140 may cause the exhaust gas to bypass one or more catalyst members of the aftertreatment system 120. In an example operating scenario, during normal operation of the aftertreatment system 120, the exhaust may flow through a first catalyst member and a second catalyst member. Responsive to implementing the aftertreatment controls, the controller 140 may cause one or more valves (not shown) to direct the exhaust gas to bypass the first catalyst member and to flow through the second catalyst member.

In some embodiments, the controller 140 may implement one or more aftertreatment controls based on comparing the characteristic of the fuel stored by the fuel system 150 (e.g., the fuel type) to one or more predetermined fuel types. Each of the predetermined fuel types may correspond to one or more aftertreatment controls. When the characteristic of the fuel stored by the fuel system 150 matches a predetermined fuel type, the controller 140 may implement the corresponding aftertreatment controls. For example, when the fuel stored by the fuel system 150 is a first fuel type, the controller 140 may implement one or more aftertreatment controls that correspond to the first fuel type, and when the fuel stored by the fuel system 150 is a second fuel type, the controller 140 may implement one or more aftertreatment controls that correspond to the second fuel type. In some embodiments, when the fuel type is a blended fuel type, the controller 140 may implement the one or more aftertreatment controls corresponding to any of the fuel types in the blended fuel type. For example, when the blended fuel type includes a first type of fuel and a second type of fuel, the controller 140 may implement the one or more aftertreatment controls corresponding to the first type of fuel or the one or more aftertreatment controls corresponding to the second type of fuel. In some embodiments, the controller 140 may implement the one or more aftertreatment controls corresponding to the fuel type having a higher well to tank emissions value.

In some embodiments, and as shown in FIG. 3, the method 300 includes both process 312 and process 314. In these embodiments, process 312 and process 314 may be performed concurrently, partially concurrently, or sequentially. Furthermore, when performed sequentially or partially concurrently, process 312 and process 314 may be performed in any order. In other embodiments, the method 300 includes only one of process 312 or process 314.

After process 312 and/or process 314, the method 300 may return to process 302. In some embodiments, the method 300 returns to process 302 responsive to the fuel system 150 receiving fuel (e.g., via refueling and/or via a storage tank replacement).

At process 320, the controller 140 compares a first well to wheel emissions value (e.g., the well to wheel emissions value regarding the fuel) to a second well to wheel emissions value (e.g., the well to wheel emissions value regarding the electrical energy).

At process 322, the controller 140 receives a location of the system 100 and/or lookahead information. As described above, the lookahead information may include information regarding the estimated well to wheel emissions value of hydrogen fuel that is available to the system 100, an indication of a schedule of the system 100, information regarding restrictive emissions areas, and/or other information regarding a path of the system 100.

At process 324, the controller 140 implements power split controls. In some embodiments, the controller 140 may adjust the power split based on a state of charge (SOC) of the battery 129 compared to a target SOC of the battery 129. For example, the controller 140 may increase the power split (e.g., such that more power is provided to the shaft 126 by the engine 102 relative to the electric machine 128) responsive to the SOC of the battery 129 being at or below the target SOC and/or at or below a predefined threshold. In another example, the controller 140 may decrease the power split (e.g., such that more power is provided to the shaft 126 by the electric machine 128 relative to the engine 102) responsive to the SOC of the battery 129 being above the target SOC and/or above a predefined threshold.

In some embodiments, the controller 140 may adjust the power split based on an availability of battery charging infrastructure. For example, the controller 140 may receive lookahead data regarding a location of a nearest charging station to the system 100 and a location of the system 100. The controller 140 may increase the power split responsive to the lookahead data indicating that a distance between the nearest charging station and the system 100 based on the location of the nearest charging station and the location of the system 100 is at or above a predetermined distance. The controller 140 may decrease the power split responsive to the lookahead data indicating that the distance between the nearest charging station and the system 100 is below a predetermined distance.

In some embodiments, the controller 140 may adjust the power split based on onboard fuel levels (e.g., an amount of fuel stored by the fuel system 150). The controller 140 may increase the power split (e.g., such that more power is provided to the shaft 126 by the engine 102 relative to the electric machine 128) responsive to the amount of fuel stored by the fuel system 150 being at or above a predetermined threshold. In another example, the controller 140 may decrease the power split (e.g., such that more power is provided to the shaft 126 by the electric machine 128 relative to the engine 102) responsive to the amount of fuel stored by the fuel system 150 being below a predetermined threshold.

In some embodiments, the controller 140 and/or a component thereof may adjust the power split based on onboard fuel levels (e.g., an amount of fuel stored by the fuel system 150) an expected fuel cost and/or an expected battery charging cost. The controller 140 may increase the power split (e.g., such that more power is provided to the shaft 126 by the engine 102 relative to the electric machine 128) responsive to the expected fuel cost being at or below a predetermined threshold and/or responsive to the expected battery charging cost being at or above a predetermined threshold. In another example, the controller 140 may decrease the power split (e.g., such that more power is provided to the shaft 126 by the electric machine 128 relative to the engine 102) responsive to the expected fuel cost being at or above a predetermined threshold and/or responsive to the expected battery charging cost being at or below a predetermined threshold.

In some embodiments, the controller 140 may adjust the power split as a function of well to wheel emissions values associated with the hydrogen fuel and the electrical energy. For example, the controller 140 may increase the power split, such that the engine 102 provides more power relative to the electric machine 128, when the first well to wheel emissions value is less than the second well to wheel emissions value. In another example, the controller 140 may decrease the power split, such that the engine 102 provides less power relative to the electric machine 128 when the first well to wheel emissions value is greater than the second well to wheel emissions value.

In some embodiments, the controller 140 may adjust the power split based on a location of the system 100, the estimated well to wheel emissions value of hydrogen fuel, and the well to wheel emissions value of electrical energy. The controller 140 may increase the power split (e.g., such that more power is provided to the shaft 126 by the engine 102 relative to the electric machine 128) responsive to the system 100 entering the restrictive emissions area and responsive to the well to wheel emissions value of the electrical energy being at or above a predetermined threshold corresponding to the restrictive emissions area. The controller 140 may decrease the power split (e.g., such that more power is provided to the shaft 126 by the electric machine 128 relative to the engine 102) responsive to the system 100 entering the restrictive emissions area and responsive to the well to wheel emissions value of the hydrogen fuel being at or above a predetermined threshold corresponding to the restrictive emissions area. In this way, as the system 100 enters an area with more restrictive emissions (e.g., based on a GPS location of the system 100 GPS, a geo-fenced area, etc.), the controller 140 may adjust the power split.

In some embodiments, the controller 140 may adjust the power split based on the estimated well to wheel emissions value of hydrogen fuel that is available to the system 100 and/or the well to wheel emissions value of electrical energy that is available to the system 100. The controller 140 may increase the power split (e.g., such that more power is provided to the shaft 126 by the engine 102 relative to the electric machine 128) responsive to the lookahead data indicating that the well to wheel emissions value of the electrical energy available to the system 100 is at or above a predetermined threshold. In another example, the controller 140 may decrease the power split (e.g., such that more power is provided to the shaft 126 by the electric machine 128 relative to the engine 102) responsive to the lookahead data indicating that the well to wheel emissions value of the hydrogen fuel available to the system 100 is at or above a predetermined threshold.

At process 318, the controller 140 generates a charging schedule. For example, the controller 140 may generate a charging schedule based on the lookahead information. More specifically, the controller 140 may generate a charging schedule for the battery 129 based on the planned downtime and the well to wheel emissions value of the electrical energy available to the system 100. For example, the controller 140 may direct an operator of the system 100 to recharge the battery 129 at a charging location based on the well to wheel emissions value of the electrical energy available at the charging location being at or below a predetermined threshold and an estimated time of arrival at the charging location being within a predetermined threshold of the planned downtime.

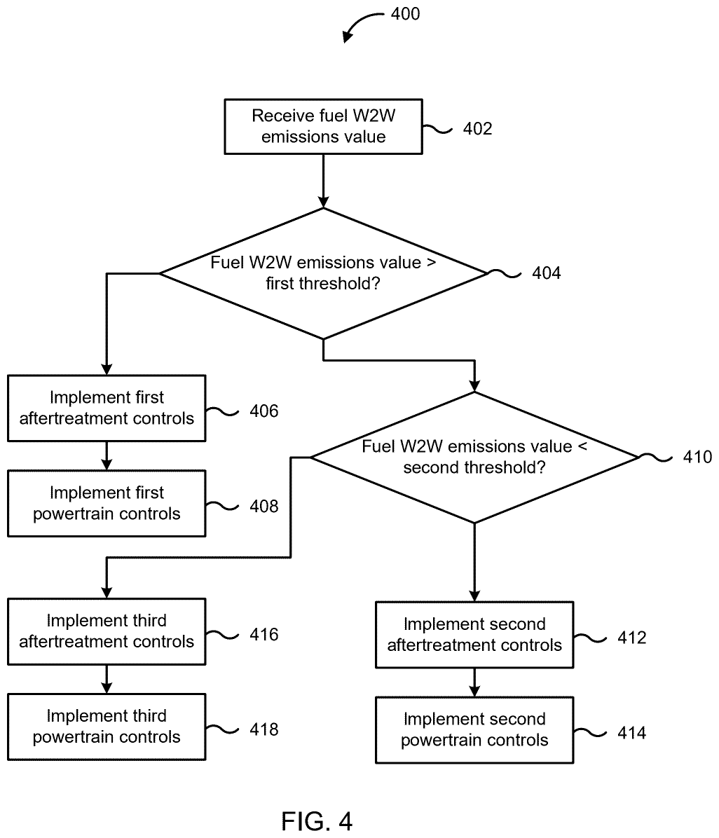

Now referring to FIG. 4, a flow diagram of a method 400 of enabling one or more aftertreatment controls and/or one or more powertrain controls is shown, according to an example embodiment. In particular, the controller 140, or a component thereof such as the powertrain control circuit 212 and/or the aftertreatment control circuit 214, is structured to enabling and/or implement one or more aftertreatment controls and/or one or more powertrain controls. As described above, enabling and/or disabling one or more aftertreatment controls and/or one or more powertrain controls may be based on a well to wheel emissions value of a fuel (e.g., hydrogen fuel) stored by the fuel system 150. It should be understood that certain of the method 400 processes may be combined in other embodiments; implemented in a different order than depicted in other embodiments; and, in some embodiments, certain of the method 400 processes may be deleted/omitted.

At process 402, the controller 140 receives a well to wheel emissions value regarding the fuel (e.g., a first well to wheel emissions value, a fuel W2W emissions value). In some embodiments, the well to wheel emissions value regarding the fuel may include an actual well to tank emissions value of the fuel and an estimated or actual tank to wheel emissions value.

At process 404, the controller 140 compares the first well to wheel emissions value to a first threshold. The first threshold may be a predetermined value. In some embodiments, the first threshold is based on a target emissions value that is defined by a regulation (e.g., a limit set by a government agency) or a goal (e.g., a desired emissions value set by a business or operator of the system 100). Responsive to the first well to wheel emissions value being at or above the first threshold, the controller 140 may proceed to process 406. Responsive to the first well to wheel emissions value being below the first threshold, the controller 140 may proceed to process 410.

At process 406, the controller 140 implements one or more first aftertreatment controls. In some embodiments, the one or more first aftertreatment controls include causing, by the controller 140, the reductant delivery system 124 to provide a first amount of reductant to the aftertreatment system 120. In some embodiments, the controller 140 implements the one or more first aftertreatment controls responsive to the well to wheel emissions value being at or above the first threshold.

At process 408, the controller 140 implements one or more first powertrain controls. In some embodiments, the one or more first powertrain controls include setting, by the controller 140, the power split to a first power split value. In some embodiments, the controller 140 implements the one or more first aftertreatment controls responsive to the well to wheel emissions value being at or above the first threshold. In some embodiments, the controller 140 may perform one or both of process 406 or process 408.

At process 410, the controller 140 compares the first well to wheel emissions value to a second threshold. The second threshold may be a predetermined value. In some embodiments, the second threshold is based on a target emissions value that is defined by a regulation (e.g., a limit set by a government agency) or a goal (e.g., a desired emissions value set by a business or operator of the system 100). In some embodiments, the second threshold is less than the first threshold. Responsive to the first well to wheel emissions value being below the second threshold, the controller 140 may proceed to process 412. Responsive to the first well to wheel emissions value being at or above the second threshold, the controller 140 may proceed to process 416.

At process 412, the controller 140 implements one or more second aftertreatment controls. In some embodiments, the one or more second aftertreatment controls include causing, by the controller 140, the reductant delivery system 124 to provide a second amount of reductant, less than the first amount, to the aftertreatment system 120. In some embodiments, the controller 140 implements the one or more second aftertreatment controls responsive to the well to wheel emissions value being at or below the second threshold.

At process 414, the controller 140 implements one or more second powertrain controls. In some embodiments, the one or more second powertrain controls include setting, by the controller 140, the power split to a second power split value, greater than the first power split value. In some embodiments, the controller 140 implements the one or more second aftertreatment controls responsive to the well to wheel emissions value being at or below the second threshold. In some embodiments, the controller 140 may perform one or both of process 412 or process 414.

At process 416, the controller 140 implements one or more third aftertreatment controls. In some embodiments, the one or more third aftertreatment controls include causing, by the controller 140, the reductant delivery system 124 to provide a third amount of reductant, less than the first amount and greater than the second amount, to the aftertreatment system 120. In some embodiments, the controller 140 implements the one or more third aftertreatment controls responsive to the well to wheel emissions value being below the first threshold and above the second threshold.

At process 418, the controller 140 implements one or more third powertrain controls. In some embodiments, the one or more third powertrain controls include setting, by the controller 140, the power split to a third power split value, greater than the first power split value and less than the second power split value. In some embodiments, the controller 140 implements the one or more third aftertreatment controls responsive to the well to wheel emissions value being above the second threshold and below the first threshold. In some embodiments, the controller 140 may perform one or both of process 416 or process 418.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 140 may include any number of circuits for completing the functions described herein. For example, the activities and functionalities of the powertrain control circuit 212 and/or the aftertreatment control circuit 214 may be combined in multiple circuits or as a single circuit. Additional circuits with additional functionality may also be included. Further, the controller 140 may further control other activity beyond the scope of the present disclosure.

As mentioned above and in one configuration, the “circuits” may be implemented in machine-readable medium for execution by one or more of various types of processors, such as the processor 204 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system comprising:
a controller coupled to a powertrain, the powertrain including an engine and electric machine, the controller comprising one or more processors and one or more memory devices storing instructions that, when executed by the one or more processors, cause the controller to perform operations comprising:
receiving a first well to wheel emissions value;
comparing the first well to wheel emissions value to a first threshold and a second threshold; and
implementing one or more aftertreatment controls or one or more powertrain controls based on comparing the first well to wheel emissions value to the first threshold and the second threshold.

2. The system of claim 1, wherein the one or more aftertreatment controls comprises:
causing a reductant delivery system to increase an amount of reductant provided to an aftertreatment system coupled to the engine responsive to the first well to wheel emissions value being at or above the first threshold; or
causing the reductant delivery system to decrease the amount of reductant provided to the aftertreatment system responsive to the first well to wheel emissions value being at or below the first threshold.

3. The system of claim 1, wherein implementing the one or more aftertreatment controls further comprises implementing a thermal management mode responsive to the first well to wheel emissions value being at or above the first threshold.

4. The system of claim 1, wherein the engine is coupled to an aftertreatment system that is configured to receive exhaust from the engine; and
wherein implementing the one or more aftertreatment controls further comprises adjusting a flow of the exhaust within the aftertreatment system.

5. The system of claim 1, wherein implementing the one or more powertrain controls comprises adjusting a power split of the engine and the electric machine of the powertrain comprising at least one of:
increasing the power split such that an engine power output by the engine increases and an electric machine power output by the electric machine decreases responsive to the first well to wheel emissions value being less than the second well to wheel emissions value; or
decreasing the power split such that the engine power output by the engine decreases and the electric machine power output by the electric machine increases responsive to the first well to wheel emissions value being greater than the second well to wheel emissions value.

6. The system of claim 5, wherein the instructions, when executed by the one or more processors, further cause the controller to perform operations comprising:
receiving a state of charge of a battery coupled to the electric machine, wherein adjusting the power split of the engine and the electric machine of the powertrain further comprises at least one of:
increasing the power split such that the engine power output by the engine increases and the electric machine power output by the electric machine decreases responsive to the state of charge of the battery being at or below a state of charge target; or
decreasing the power split such that the engine power output by the engine decreases and the electric machine power output by the electric machine increases responsive to the state of charge of the battery being above the state of charge target.

7. The system of claim 5, wherein the instructions, when executed by the one or more processors, further cause the controller to perform operations comprising:
receiving lookahead data regarding a first location regarding a charging station and a second location regarding the system, wherein adjusting the power split of the engine and the electric machine of the powertrain further comprises at least one of:
increasing the power split such that the engine power output by the engine increases and the electric machine power output by the electric machine decreases responsive to a distance between the first location and the second location being at or above a predetermined distance, or
decreasing the power split such that the engine power output by the engine decreases and the electric machine power output by the electric machine increases responsive to the distance between the first location and the second location being below the predetermined distance.

8. The system of claim 1, wherein implementing the one or more powertrain controls comprises at least one of:
adjusting one or more engine operating parameters to reduce an emissions value associated with consuming a fuel responsive to the first well to wheel emissions value being at or above the first threshold; or
adjusting the one or more engine operating parameters to increase a fuel economy value associated with consuming the fuel responsive to the first well to wheel emissions value being at or below the second threshold.

9. The system of claim 1, wherein implementing the one or more powertrain controls comprises adjusting a transmission shift schedule.

10. A method comprising:
receiving a first well to wheel emissions value regarding a fuel stored at a fuel system coupled to an engine;
comparing the first well to wheel emissions value to at least one of a first threshold or a second threshold; and
implementing one or more controls comprising at least one of:
causing a reductant delivery system to provide a first amount of reductant to an aftertreatment system coupled to the engine responsive to the first well to wheel emissions value being at or above the first threshold; or
causing the reductant delivery system to provide a second amount of reductant to the aftertreatment system responsive to the first well to wheel emissions value being at or below the second threshold, wherein the second amount of reductant is less than the first amount of reductant.

11. The method of claim 10, further comprising causing the reductant delivery system to provide a third amount of reductant to the aftertreatment system responsive to the first well to wheel emissions value being below the first threshold and above the second threshold, wherein the third amount of reductant is greater than the first amount and less than the second amount.

12. The method of claim 10, further comprising:
setting a power split of a powertrain comprising the engine and an electric machine, wherein setting the power split comprises at least one of:
setting the power split to a first value responsive to the first well to wheel emissions value being at or above the first threshold; or
setting the power split to a second value responsive to the first well to wheel emissions value being at or below the second threshold, wherein the second value is greater than the first value.

13. The method of claim 12, further comprising setting the power split to a third value responsive to the first well to wheel emissions value being below the first threshold and above the second threshold, wherein the third value is greater than the first value and less than the second value.

14. A method comprising:
receiving a characteristic regarding a fuel stored at a fuel system coupled to an engine; and
implementing one or more aftertreatment controls or one or more powertrain controls based on the received characteristic.

15. The method of claim 14, wherein the one or more powertrain controls comprise at least one of:
adjusting a power split such that an engine power output by the engine changes, based on the received characteristic, or
adjusting one or more engine operating parameters to change an emissions value associated with consuming the fuel based on the received characteristic.

16. The method of claim 14, wherein the one or more aftertreatment controls comprise at least one of:
causing a reductant delivery system to adjust an amount of reductant provided to an aftertreatment system coupled to the engine based on the received characteristic, or
adjusting a flow of an exhaust gas within the aftertreatment system based on the received characteristic.

17. The method of claim 16, wherein adjusting the flow of the exhaust gas within the aftertreatment system based on the received characteristic comprises:
causing a valve to direct the exhaust gas to bypass a first catalyst member and to flow through a second catalyst member responsive to the characteristic being at or above a predetermined threshold; and
causing the valve to direct the exhaust gas to flow through the first catalyst member and the second catalyst member responsive to the characteristic being below the predetermined threshold.

18. A method comprising:
receiving a characteristic regarding a fuel stored at a fuel system coupled to an engine, the characteristic comprising an indication of a blend characteristic of the fuel stored at the fuel system; and
implementing one or more aftertreatment controls or one or more powertrain controls based on the characteristic.

19. The method of claim 18, wherein the characteristic include a well to wheel emissions value, and implementing the one or more aftertreatment controls or the one or more powertrain controls is based on comparing the well to wheel emissions value to a predetermined threshold.

20. The method of claim 18, wherein:
the blend characteristic indicates that the fuel stored at the fuel system includes a first amount of a first type of fuel having a first well to wheel emissions value and a second amount of a second type of fuel, different than the first type of fuel and having a second well to wheel emissions value different than the first well to wheel emissions value;
the one or more characteristics include the first well to wheel emissions value and the second well to wheel emissions value; and
implementing the one or more aftertreatment controls or the one or more powertrain controls is based on:
the first well to wheel emissions value when the first well to wheel emissions value is greater than the second well to wheel emissions value, or
the second well to wheel emissions value when the second well to wheel emissions value is greater than the first well to wheel emissions value.
